(19) United States
(12) Patent Application Publication
(10) Pub. No.: US 2019/0222834 A1
(43) Pub. Date: Jul. 18, 2019

(54) VARIABLE AFFINE MERGE CANDIDATES FOR VIDEO CODING

(71) Applicant: MEDIATEK INC., Hsin-Chu (TW)

(72) Inventors: Chun-Chia CHEN, Hsin-Chu (TW); Chih-Wei HSU, Hsin-Chu (TW); Ching-Yeh CHEN, Hsin-Chu (TW)

(73) Assignee: MEDIATEK INC., Hsin-Chu (TW)

(21) Appl. No.: 16/245,967

(22) Filed: Jan. 11, 2019

Related U.S. Application Data
(60) Provisional application No. 62/618,659, filed on Jan. 18, 2018.

(51) Int. Cl. H04N 19/105; H04N 19/122; H04N 19/149; H04N 19/176

(52) U.S. Cl. CPC H04N 19/105; H04N 19/176; H04N 19/149; H04N 19/122

(57) ABSTRACT

Aspects of the disclosure provide a method for video coding. The method includes determining a set of affine merge candidate (AMC) positions of a set of AMC blocks coded using affine motion models for a current block in a current picture. The set of AMC blocks includes at least one of: a set of AMC side blocks that are spatially neighboring blocks located on one or more sides of the current block in the current picture and an AMC temporal block in a reference picture of the current block. The current block is predicted from the reference picture using a merge mode. The method includes generating a set of affine merge candidates for the current block corresponding to the set of AMC blocks, and constructing a merge candidate list for the current block including the set of affine merge candidates.

### INCORPORATION BY REFERENCE

This present disclosure claims the benefit of U.S. Provisional Application No. 62/618,659, “A new affine mode processing method for video coding in merge mode” filed on Jan. 18, 2018, which is incorporated herein by reference in its entirety.

### TECHNICAL FIELD

The present disclosure relates to video coding techniques.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

In image and video coding, pictures and their corresponding sample arrays can be partitioned into blocks using tree structure based schemes. Then, each block can be processed with one of multiple processing modes. Merge mode is one of such processing modes in which spatially or temporally neighboring blocks can share a same set of motion parameters. Encoders and decoders follow the same rule to construct the prediction candidate list, and an index indicating the selected prediction candidate is transmitted from an encoder to a decoder. As a result, motion vector transmission overhead can be reduced.

### SUMMARY

Aspects of the disclosure provide a method for video coding. The method includes determining a set of affine merge candidate (AMC) positions of a set of AMC blocks coded using affine motion models for a current block in a current picture. The set of AMC blocks includes at least one of: a set of AMC side blocks that are spatially neighboring blocks located on one or more sides of the current block in the current picture and an AMC temporal block in a reference picture of the current block. The current block is predicted from the reference picture using a merge mode. The method includes generating a set of affine merge candidates for the current block corresponding to the set of AMC blocks, and constructing a merge candidate list for the current block including the set of affine merge candidates.

In an embodiment, the set of AMC side blocks is determined based on one of: size information and shape information of the current block.

In an embodiment, the method includes determining a number of the set of AMC side blocks based on one of: the size information and the shape information of the current block where the size information includes at least one of: a height of the current block, a width of the current block, and an area of the current block, and the shape information includes an aspect ratio of the current block.

In an example, the set of AMC side blocks includes a set of AMC top blocks located on a top side of the current block and determining the number of the set of AMC side blocks includes determining a number of the set of AMC top blocks based on the width of the current block and/or the aspect ratio of the current block.

In an example, the set of AMC side blocks includes a set of AMC left blocks located on a left side of the current block and determining the number of the set of AMC side blocks includes determining a number of the set of AMC left blocks based on the height of the current block and/or the aspect ratio of the current block.

In an embodiment, one of the set of AMC positions is of one of the set of AMC side blocks and determining the set of AMC positions comprises determining the one of the set of AMC positions based on one of: the size information and the shape information of the current block.

In an example, the set of AMC side blocks includes a set of AMC top blocks located on a top side of the current block and one of the set of AMC top blocks is located at the one of the set of AMC positions. Determining the one of the set of AMC positions includes determining the one of the set of AMC positions based on at least one of: the width of the current block, the aspect ratio of the current block, and a number of the set of AMC top blocks.

In an example, the set of AMC side blocks includes a set of AMC left blocks located on a left side of the current block and one of the set of AMC left blocks is located at the one of the set of AMC positions. Determining the one of the set of AMC positions includes determining the one of the set of AMC positions based on at least one of: the height of the current block, the aspect ratio of the current block, and a number of the set of AMC left blocks.

In an example, the AMC temporal block is within a collocated block of the current block where the collocated block is in the reference picture of the current block. In another example, the AMC temporal block is located at one of: a bottom-right corner, a top-right corner, and a bottom-left corner of the collocated block of the current block.

In an embodiment, for one of the set of AMC blocks, the method further comprises identifying an affine-coded coding block for the one of the set of AMC blocks and obtaining first control points of the affine-coded coding block. Subsequently, the method includes determining, based on first motion vectors of the first control points, second motion vector predictors of second control points for the current block. The second motion vector predictors are one of the set of affine merge candidates corresponding to the one of the set of AMC blocks.

Aspects of the disclosure provide an apparatus for video coding. The apparatus includes processing circuitry that is configured to determine a set of affine merge candidate (AMC) positions of a set of AMC blocks coded using affine motion models for a current block in a current picture. The set of AMC blocks includes at least one of: a set of AMC side blocks that are spatially neighboring blocks located on one or more sides of the current block in the current picture and an AMC temporal block in a reference picture of the current block. The current block is predicted from the reference picture using a merge mode. The processing circuitry is further configured to generate a set of affine merge candidates for the current block corresponding to the set of AMC blocks, and construct a merge candidate list for the current block including the set of affine merge candidates.

Aspects of the disclosure provide a non-transitory computer-readable medium that stores instructions implementing the method for video coding.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows an example video encoder according to an embodiment of the disclosure;

FIG. 2 shows an example video decoder according to an embodiment of the disclosure;

FIGS. 3A-3C show a first tree-based partitioning schemes for partitioning a picture according to an embodiment of the disclosure;

FIGS. 4A-4C show a second tree-based partitioning schemes for partitioning a picture according to an embodiment of the disclosure;

FIGS. 5A-5B show a third tree-based partitioning schemes for partitioning a picture according to an embodiment of the disclosure;

FIG. 6 shows candidate positions for merge mode processing according to an embodiment of the disclosure;

FIG. 7A-7B show examples of affine motion models according to embodiments of the disclosure;

FIG. 8 shows an example of a current block and spatial neighboring blocks according to an embodiment of the disclosure;

FIG. 9 shows an example of determining MVs for a block coded in an affine merge mode;

FIG. 10 shows an example of an AMC side position according to an embodiment of the disclosure;

FIGS. 11A-11B and 12A-12B show examples of the variable AMC approach according to embodiments of the disclosure;

FIGS. 13A-13C show examples of the variable AMC approach according to embodiments of the disclosure;

FIG. 14 shows examples of the variable AMC approach according to an embodiment of the disclosure;

FIG. 15A-15D show examples of an AMC temporal block of a current block;

FIG. 16 shows an encoding process according to an embodiment of the disclosure; and

FIG. 17 shows a decoding process according to an embodiment of the disclosure.

### DETAILED DESCRIPTION OF EMBODIMENTS

A video coder, such as an encoder, a decoder, or the like, can code a current block in a current picture using an inter prediction including a merge mode. Further, an affine motion model can be used to predict motion information such as motion vectors (MVs) of samples in the current block, and thus the motion information such as the MVs of the samples in the current block can be different. In the merge mode, the affine motion model of the current block can be obtained from a merge candidate list that includes affine merge candidates (AMCs). The affine merge candidates indicate candidate affine motion models for the current block and can be derived from affine-coded spatial neighboring blocks of the current block.

According to aspects of the disclosure, the affine-coded spatial neighboring blocks can include affine-coded side neighboring blocks that are located on one or more sides of the current block and not at or near a corner of the current block. In an example, the affine-coded side neighboring blocks can be located at or near a middle position of a side of the current block. An affine-coded side neighboring block from which an affine merge candidate can be derived is referred to as an affine merge candidate side block or an AMC side block, and a position of the AMC side block on the respective side of the current block can be referred to as an AMC side position. An affine merge candidate derived from an AMC side block is referred to as a side AMC. According to aspects of the disclosure, a number of AMC side blocks or a number of side AMCs or a number of AMC side positions on a side of the current block can be determined based on a shape and/or a size of the current block, and the number can be any suitable integer that is equal to or larger than zero. Further, an AMC side position can be determined by the shape and/or the size of the current block. Alternatively or additionally, an affine merge candidate can be derived from a temporal block in a reference picture of the current block, and thus the above temporal block can be referred to as an AMC temporal block from which the temporal AMC is derived. The term “an AMC block” can refer to either an AMC side block or an AMC temporal block, and the term “an AMC position” can refer to either an AMC side position or a position of an AMC temporal block.

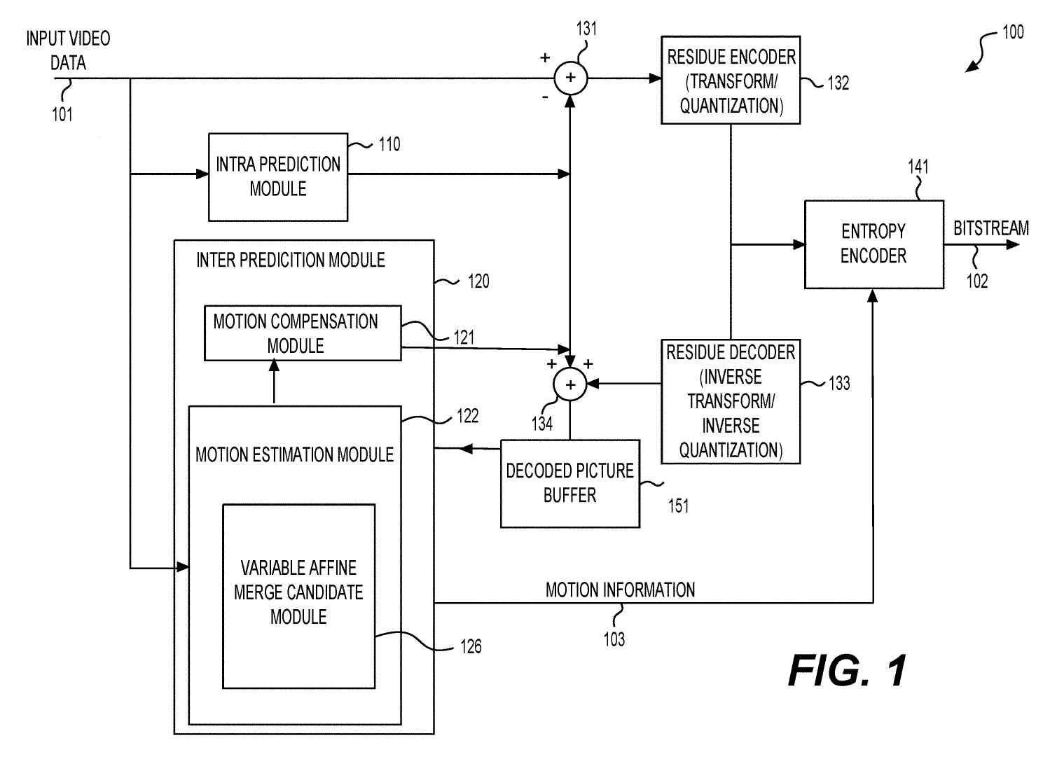

FIG. 1 shows an example video encoder 100 according to an embodiment of the disclosure. The encoder 100 can include an intra prediction module 110, an inter prediction module 120, a first adder 131, a residue encoder 132, an entropy encoder 141, a residue decoder 133, a second adder 134, and a decoded picture buffer 151. The inter prediction module 120 can further include a motion compensation module 121, and a motion estimation module 122. The above components can be coupled together as shown in FIG. 1.

In an embodiment, the encoder 100 receives input video data 101 and performs a video compression process to generate a bitstream 102 as an output. The input video data 101 can include a sequence of pictures. Each picture can include one or more color components, such as a luma component or a chroma component. The bitstream 102 can have a format compliant with a video coding standard, such as an Advanced Video Coding (AVC) standard, a High Efficiency Video Coding (HEVC) standard, a Versatile Video Coding (VVC) standard, and/or the like.

The encoder 100 can partition a picture in the input video data 101 into blocks, for example, using tree structure based partition schemes. The resulting blocks can then be processed with different processing modes, such as an intra prediction mode, an inter prediction with an inter mode, an inter prediction with a merge mode, and the like. In one example, when a current block is processed with the merge mode, a spatially neighboring block (or a spatial neighbor) in the picture can be selected for the current block. The current block can be merged with the selected neighboring block, and share motion data of the selected neighboring block. The merge mode operation can be performed over a group of blocks such that a region of the group of blocks can be merged together, and share the same motion data. During transmission, an index indicating the selected neighboring block can be transmitted for the merged region, thus improving transmission efficiency.

A current block in a current picture can have multiple spatially neighboring blocks that are in the current picture. When the current block is affine-coded in a merge mode, AMC side blocks located at corresponding AMC side positions are a subset of the multiple spatially neighboring blocks. Similarly, the current block can have multiple temporal blocks located at a reference picture that includes a collocated block of the current block, and the multiple temporal blocks can surround, overlap with, or be within the collocated block. An AMC temporal block can be selected from the multiple temporal blocks.

Generally, partition of a picture into blocks can be adaptive to local content of the picture. Accordingly, the blocks can have variable sizes and shapes at different locations of the picture. According to an aspect of the disclosure, the encoder 100 can employ a variable AMC approach to determine AMC side positions of AMC side blocks for merge mode processing. Specifically, a number and locations of AMC side positions can be determined according to a size and/or a shape of the current block. As described above, an affine merge candidate can also be a temporal AMC derived from an AMC temporal block.

In related video coding techniques, a number and locations of affine merge candidates can be fixed for different shapes and sizes of the blocks. By including side AMCs derived from AMC side blocks and a temporal AMC derived from an AMC temporal block and by varying a number of side AMCs, the variable AMC approach can provide more suitable affine merge candidates for the current block and thus improve coding efficiency.

In FIG. 1, the intra prediction module 110 can be configured to perform intra prediction to determine a prediction for a current block during the video compression process. The intra prediction can be based on neighboring pixels of the current block within a same picture as the current block.

The inter prediction module 120 can be configured to perform an inter prediction to determine a prediction for a current block during the video compression process. For example, the motion compensation module 121 can receive motion data of the current block from the motion estimation module 122. In one example, the motion data can include horizontal and vertical motion vector displacement values, one or two reference picture indices, and optionally an identification of a reference picture list that is associated with each reference picture index. Based on the motion data and one or more reference pictures stored in the decoded picture buffer 151, the motion compensation module 121 can determine the prediction for the current block.

The motion estimation module 122 can be configured to determine the motion data for the current block. In an embodiment, an affine motion model can be used to predict MVs of samples in the current block, and thus a MV of each sample in the current block relative to a reference picture can be derived based on the affine motion model. An affine motion model can be specified by, for example, multiple MVs at respective locations of the current block. The respective locations can be referred to as control points of the block. In an example, 3 MVs at 3 control points of the current block is used to describe an affine motion model, and thus, the affine motion model is a six-parameter affine motion model. In another example, 2 MVs at 2 control points of the current block is used to describe an affine motion model, and thus, the affine motion model is a four-parameter affine motion model.

The current block can be processed with an inter mode, a merge mode, or the like in the motion estimation module 122. When the block is processed with an inter mode, the motion estimation module 122 can perform a motion estimation process searching for a reference block similar to the current block in one or more reference pictures. Such a reference block can be used as the prediction of the current block. In one example, one or more MVs and corresponding reference pictures can be determined as a result of the motion estimation process depending on unidirectional or bidirectional prediction method is used. For example, the resulting reference pictures can be indicated by reference picture indices and, in case of bidirectional prediction is used, corresponding reference picture list identifications.

The motion estimation module 122 can include a variable AMC module 126. When the current block is processed with a merge mode, and an affine motion model is used for the current block, the variable AMC module 126 can determine a number and locations of side AMCs for the merge mode. The variable AMC module 126 can also determine a temporal AMC derived from an AMC temporal block and other suitable merge candidates. A first merge candidate list can be constructed based on merge candidates including the side AMCs, the temporal AMC, and/or the other suitable merge candidates. The first merge candidate list can include multiple entries. Each entry corresponds to a merge candidate and can include motion data of a corresponding candidate block, such as an AMC side block, an AMC temporal block, an AMC corner block, a non-affine-coded spatial neighboring block, or the like. Further, the variable AMC module 126 can select a merge candidate from the first merge candidate list. For example, each entry can then be evaluated and motion data having highest rate-distortion performance can be determined to be shared by the current block. Then, the to-be-shared motion data can be used as the motion data of the current block. In addition, an index of the entry including the to-be-shared motion data or the merge candidate in the first merge candidate list can be used for indicating and signaling the selection. Such an index is referred to as a merge index. In an example, the to-be-shared motion data or the merge candidate corresponds to an affine merge candidate that can include three MVs, and the three MVs can be used to predict MVs of samples in the current block.

The motion data of the current block determined at the motion estimation module 122 can be supplied to the motion compensation module 121. In addition, motion information 103 related with the motion data can be generated and provided to the entropy encoder 141, and subsequently signaled in the bitstream 102, for example, to a video decoder. For the inter mode, the resulting motion data can be provided to the entropy encoder 141. For the merge mode, a merge flag can be generated and associated with the current block indicating the current block being processed with the merge mode. The merge flag and a corresponding merge index can be included in the motion information 103 and signaled in the bitstream 102 to, for example, a video decoder. The video decoder can derive the motion data based on the merge index when processing the same block with the merge mode.

In an example, a skip mode can be used as a special case of the merge mode described above by the inter prediction module 120. In the skip mode, the current block can be predicted using the merge mode similarly as described above to determine the motion data, however, no residue is generated or transmitted. A skip flag can be associated with the current block. The skip flag and an index indicating the related motion information of the current block can be signaled in the bitstream 102, for example, to a video decoder. At the video decoder side, a prediction determined based on the related motion information can be used as a decoded block without adding residue signals. Thus, the variable AMC approach can be utilized in combination with the skip mode. For example, after operations of merge mode are performed on a current block, and related motion information including a merge index is determined, a skip mode flag can be associated with the current block to indicate the skip mode. For purposes of clarity, the term ‘merge mode’ in the disclosure includes cases where residual data may be transmitted and other cases where residual data is zero and not coded.

Multiple processing modes are described above, such as an intra prediction mode, an inter prediction with inter mode, an inter prediction with a merge mode. Generally, different blocks can be processed with different processing modes, and a mode decision can be made, for example, based on test results of applying different processing modes on one block. The test results can be evaluated based on a rate-distortion performance of respective processing modes. A processing mode having an optimal result can be determined as the choice for processing the block. In alternative examples, other methods can be employed to determine a processing mode. For example, characteristics of a picture and blocks partitioned from the picture may be considered for determination of a processing mode.

The first adder 131 receives a prediction of a current block from either the intra prediction module 110 or the motion compensation module 121, and the current block from the input video data 101. The first adder 131 can then subtract the prediction from pixel values of the current block to obtain a residue of the current block. The residue of the current block is transmitted to the residue encoder 132.

The residue encoder 132 receives residues of blocks, and compresses the residues to generate compressed residues. For example, the residue encoder 132 may first apply a transform, such as a discrete cosine transform (DCT), a wavelet transform, and/or the like, to received residues corresponding to a transform block and generate transform coefficients of the transform block. Partition of a picture into transform blocks can be the same as or different from partition of the picture into prediction blocks for an inter or an intra prediction processing. Subsequently, the residue encoder 132 can quantize the transform coefficients to compress the residues. The compressed residues or quantized transform coefficients are sent to the residue decoder 133 and the entropy encoder 141.

The residue decoder 133 receives the compressed residues and performs an inverse process of the quantization and transformation operations performed at the residue encoder 132 to reconstruct residues of a transform block. Due to the quantization operation, the reconstructed residues are similar to the original residues generated from the adder 131 but may not be identical to the original residues.

The second adder 134 receives predictions of blocks from the intra prediction module 110 or the motion compensation module 121, and reconstructed residues of transform blocks from the residue decoder 133. The second adder 134 subsequently combines the reconstructed residues with the received predictions corresponding to a same region in the picture to generate reconstructed video data. The reconstructed video data can be stored in the decoded picture buffer 151 forming reference pictures that can be used for the inter prediction operations.

The entropy encoder 141 can receive the compressed residues from the residue encoder 132, and the motion information 103 from the inter prediction module 120. The entropy encoder 141 can also receive other parameters and/or control information, such as intra prediction mode information, quantization parameters, and the like. The entropy encoder 141 encodes the received parameters or information to form the bitstream 102. The bitstream 102 including data in a compressed format can be transmitted to, for example, a decoder via a communication network, or transmitted to a storage device (e.g., a non-transitory computer-readable medium) where video data carried by the bitstream 102 can be stored.

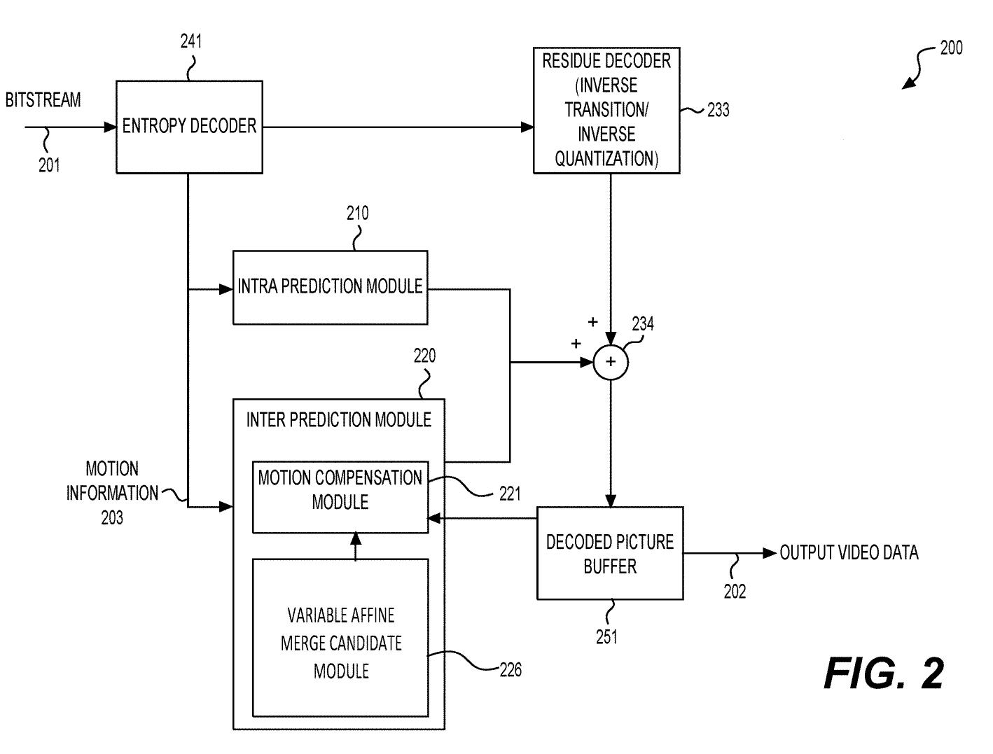

FIG. 2 shows an example video decoder (or decoder) 200 according to an embodiment of the disclosure. The decoder 200 can include an entropy decoder 241, an intra prediction module 210, an inter prediction module 220 that includes a motion compensation module 221 and a variable AMC module 226, a residue decoder 233, an adder 234, and a decoded picture buffer 251. The components can be coupled together as shown in FIG. 2. In one example, the decoder 200 receives a bitstream 201 from, for example, a video encoder, such as the bitstream 102 from the encoder 100, and performs a decompression process to generate output video data 202. The output video data 202 can include a sequence of pictures that can be displayed, for example, on a display device, such as a monitor, a touch screen, and the like.

Similarly to the encoder 100 in FIG. 1 example, the decoder 200 can employ the variable affine merge candidate approach to process a current block that is encoded with a merge mode and is predicted using an affine motion model. For example, the decoder 200 can be configured similarly or identically as the encoder 100 to determine a number and locations of side AMCs for the current block when encoding the current block. Specifically, the variable AMC module 226 can function similarly as the variable AMC module 126. For example, the variable AMC module 226 can determine the number and the locations of side AMCs for the current block, and can determine a temporal AMC derived from an AMC temporal block and other suitable merge candidates. A second merge candidate list identical to the first merge candidate list can be constructed by the variable AMC module 226. Based on a merge index received in the bitstream 201, a merge candidate including motion data from the second merge candidate list can be determined.

The entropy decoder 241 receives the bitstream 201 and performs a decoding process which can be an inverse process of the encoding process performed by the entropy encoder 141 in the FIG. 1 example. As a result, motion information 203, intra prediction mode information, compressed residues, quantization parameters, control information, and/or the like, can be obtained. The compressed resides can be provided to the residue decoder 233.

The intra prediction module 210 can receive the intra prediction mode information and generate predictions for blocks encoded with an intra prediction mode. The inter prediction module 220 can receive the motion information 203 from the entropy decoder 241, and generate predictions for blocks encoded with an inter prediction mode, such as a merge mode. The merge mode can include a skip mode. For example, for a block encoded with an inter mode, motion data corresponding to the block can be obtained from the motion information 203 and provided to the motion compensation module 221. For a block encoded with a merge mode, a merge index can be obtained from the motion information 203, and the process of deriving motion data based on the variable AMC approach described herein can be performed at the variable AMC module 226. The motion data can be provided to the motion compensation module 221. Based on the received motion data and reference pictures stored in the decoded picture buffer 251, the motion compensation module 221 can generate predictions for the block which is provided to the adder 234.

The residue decoder 233, the adder 234 can be similar to the residue decoder 133 and the second adder 134 in the FIG. 1 example in terms of functions and structures. Particularly, for blocks encoded with a skip mode, no resides are generated for the blocks. The decoded picture buffer 251 stores reference pictures for motion compensation performed at the motion compensation module 221. The reference pictures, for example, can be formed by reconstructed video data received from the adder 234. In addition, reference pictures can be obtained from the decoded picture buffer 251 and included in the output video data 202 for displaying on a display device.

In various embodiments, the variable AMC modules 126 and 226 and other components of the encoder 100 and decoder 200 can be implemented with any suitable hardware, software, or combination thereof. For example, the variable AMC modules 126 and 226 can be implemented with one or more integrated circuits (ICs), such as an application specific integrated circuit (ASIC), field programmable gate array (FPGA), and/or the like. In another example, the variable AMC modules 126 and 226 can be implemented as software or firmware including instructions stored in a computer readable non-volatile storage medium. The instructions, when executed by one or more processing circuits, causing the one or more processing circuits to perform functions of the variable AMC modules 126 and/or 226.

The variable AMC modules 126 and 226 implementing the variable AMC approach disclosed herein can be included in other decoders or encoders that may have similar or different structures from what is shown in FIG. 1 or FIG. 2. In addition, the encoder 100 and decoder 200 can be included in a same device, or separate devices in various examples.

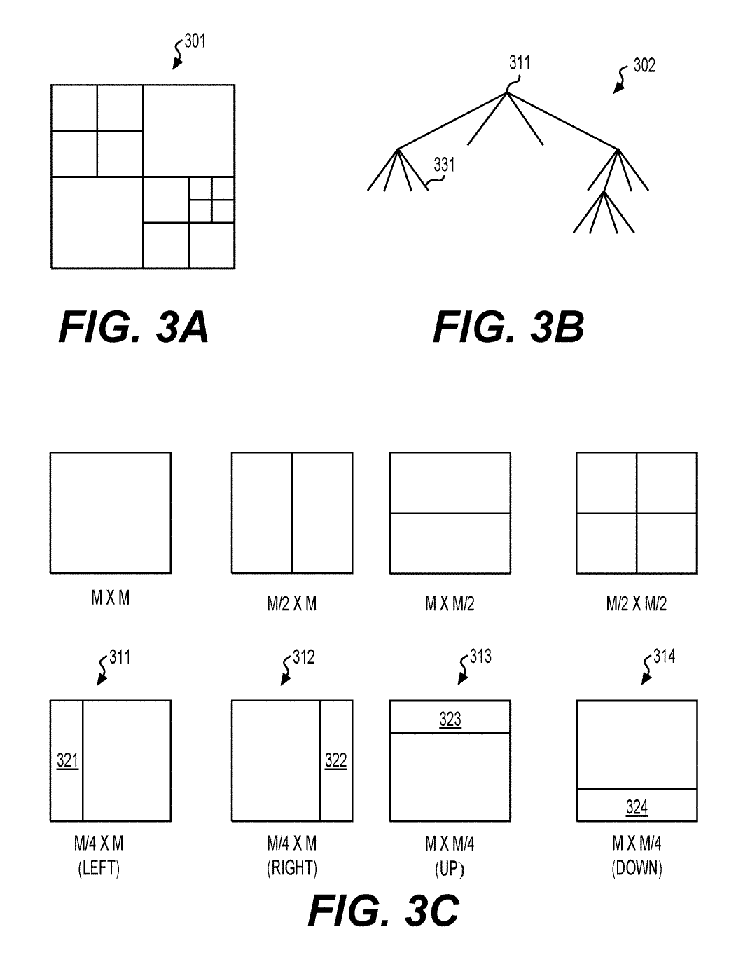

FIGS. 3A-3C show a first tree-based partitioning schemes for partitioning a picture according to an embodiment of the disclosure. The first tree-based partitioning scheme is based on a quadtree structure and can be used in the HEVC standard. As an example, as specified in the HEVC standards, a picture can be partitioned into slices, and a slice can be further partitioned into coding tree blocks (CTBs). A CTB can have a square shape of a size of 8×8, 16×16, 32×32, or 64×64. A CTB can be partitioned into coding blocks (CB) using the quadtree structure.

FIG. 3A shows an example of a CTB 301 that is partitioned into multiple CBs. FIG. 3B shows a quadtree 302 corresponding to a process of partitioning the CTB 301. As shown, the CTB 301 is a root 311 of the quadtree 302, and leaf nodes of the quadtree 302 (such as a leaf node 331) correspond to CBs in the CTB 301. Sizes of the CBs from a partitioning process can be adaptively determined according to local content of a picture including the CTB 301. Depth of the quadtree 302 and a minimum size of CBs can be specified in a syntax element of a bit stream carrying the coded picture.

In some examples, such as in the HEVC standard, a CB can be further partitioned once to form prediction blocks (PB) for intra or inter prediction processing. FIG. 3C shows 8 PB partitioning types such as used in the HEVC standard. As shown, a CB can be split into 1, 2 or 4 PBs. In FIG. 3C, a width and a height of a PB are shown below the respective CB where M represents a side length of the CB. In the bottom row of FIG. 3C, the widths and the heights of the PBs 321-324 are indicated below the CBs 311-314, respectively.

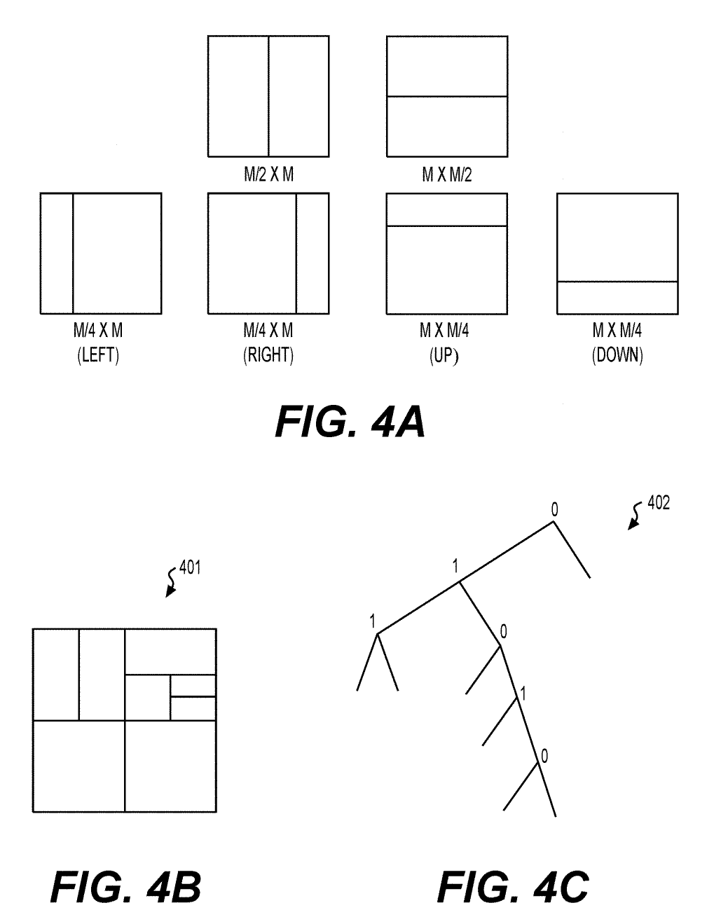

FIGS. 4A-4C show a second tree-based partitioning schemes for partitioning a picture according to an embodiment of the disclosure. The second tree-based partitioning scheme is based on a binary tree structure and can be used to partition a CTB such as defined in the HEVC standard. FIG. 4A shows 6 partitioning types that can be used for splitting a block into a smaller block. Similar to FIG. 3C, a width and a height of a resulting sub-block are shown below each respective block where M represents a side length of the block. For example, a CTB can be split recursively using the partitioning types shown in FIG. 4A until a width or a height of a sub-block reaches a minimum block width or height.

FIG. 4B shows an example of a CTB 401 that is partitioned into CBs using the binary tree structure. FIG. 4C shows a binary tree 402 corresponding to a process for partitioning the CTB 401. In FIG. 4B and FIG. 4C examples, only the symmetric vertical and horizontal partitioning types (M/2×M and M×M/2) are used. At each non-leaf node of the binary tree 402, a flag (0 or 1) is labeled to denote whether a horizontal or a vertical partitioning is used: 0 indicates a horizontal splitting, and 1 indicates a vertical splitting. Each lead node of the binary tree 402 represents a CB. The CBs can be used as PBs without further splitting in some examples.

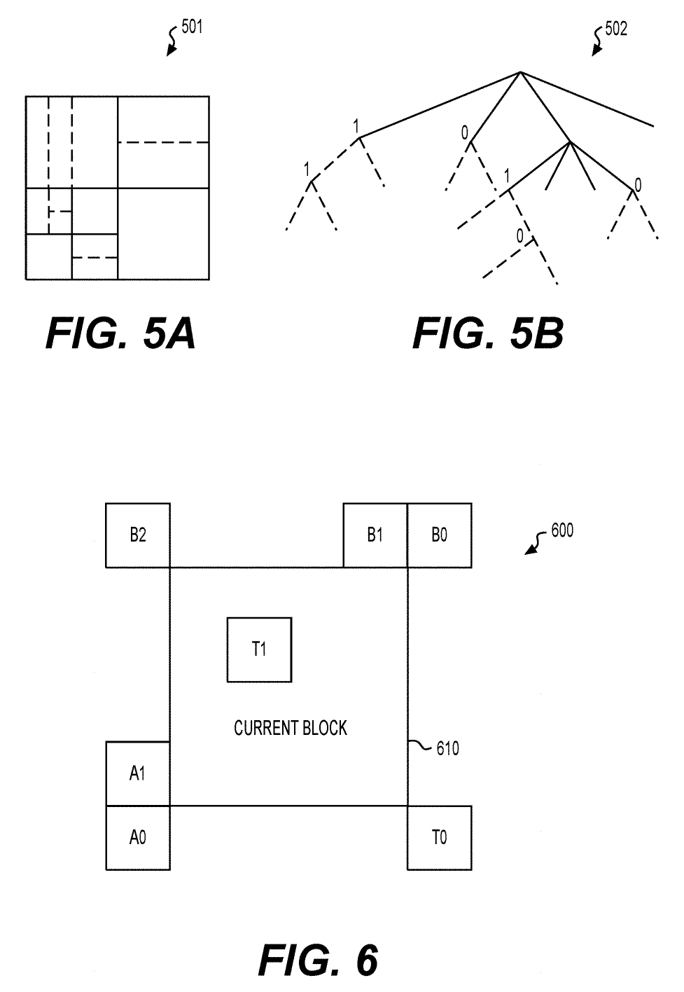

FIGS. 5A-5B show a third tree-based partitioning scheme for partitioning a CTB according to an embodiment of the disclosure. The third tree-based partitioning scheme is based on a quadtree plus binary tree (QTBT) structure and can be used to partition a CTB defined in the HEVC standard. FIG. 5A shows an example of a CTB 501 that is partitioned using the QTBT structure. In FIG. 5A, solid lines represent boundaries of blocks partitioned based on the quadtree structure while dashed lines represent boundaries of blocks partitioned based on the binary tree structure. FIG. 5B shows a tree 502 based on the QTBT structure. The tree 502 corresponds to a process for partitioning the CTB 501. Solid lines represent partitioning based on the quadtree structure while dashed lines represent partitioning based on the binary tree structure.

As shown, during a QTBT based partitioning process, a CTB can be first partitioned using a quadtree structure recursively until a size of blocks reaches a minimum leaf node size. Thereafter, if a leaf quadtree block is not larger than a maximum allowed binary tree root node size, the leaf quadtree block can be further split based on the binary tree structure. The binary splitting can be iterated until a width or a height of blocks reaches a minimum allowed width or height, or until the binary tree depth reaches a maximum allowed depth. The CBs (leaf blocks) generated from the QTBT based partitioning process can be used as PBs without further splitting in some examples.

FIG. 6 shows candidate positions used in a merge mode according to an embodiment of the disclosure. A current block 610 in a current picture is to be processed with the merge mode. A merge candidate list for the current block 610 can include merge candidates, such as spatial candidates and temporal candidates. The spatial candidates include motion information from spatial candidate blocks that are spatially neighboring blocks of the current block 610, and temporal candidates include motion information from temporal candidate blocks that are temporal blocks located at a reference picture that includes a collocated block of the current block 610. The term “candidate blocks” are used to describe the spatial and/or temporal candidate blocks, and positions of the candidate blocks are referred to as candidate positions. A set of candidate positions {A0, A1, B1, B1, B2, T0, T1} can be determined for the merge mode. Specifically, the candidate positions {A0, A1, B0, B1, B2} are spatial candidate positions that represent positions of spatial candidate blocks that are in the current picture as the current block 610. In contrast, candidate positions {T0, T1} are temporal candidate positions that represent positions of temporal candidate blocks that are in the reference picture. The candidate position T1 can be near or at a center of a collocated block of the current block 610.

In FIG. 6, a candidate block corresponding to a candidate position can include multiple samples, such as 4×4 samples. A size of the candidate block can be equal to or smaller than a minimum allowed size (e.g., 4×4 samples) of the block 610. A candidate position can be represented by a sample within the respective candidate block.

In one example, based on the candidate positions {A0, A1, B0, B1, B2, T0, T1} in FIG. 6, a merge mode process can be performed to select a candidate block from the candidate positions {A0, A1, B0, B1, B2, T0, T1}. In the merge mode process, a merge candidate list can be constructed. The merge candidate list can have a predefined maximum number C of merge candidates. Each merge candidate in the merge candidate list can include motion data that can be used for motion prediction. In one example, according to a predefined order, a first number C1 of merge candidate is derived from the spatial candidate positions {A0, A1, B0, B1, B2}, and a second number C2=C−C1 of merge candidate is derived from the temporal candidate positions {T0, T1}.

In some scenarios, a merge candidate at a candidate position may be unavailable. For example, a candidate block at a candidate position can be intra-predicted, or a candidate block is outside of a slice including the current block 610. In some scenarios, a merge candidate at a candidate position may be redundant. The redundant merge candidate can be removed from the candidate list. When a total number of merge candidates in the candidate list is smaller than the maximum number C of merge candidate, additional merge candidates can be generated (for example, according to a preconfigured rule) to fill the candidate list such that the candidate list can be maintained to have a fixed length.

According to aspects of the disclosure, the merge candidate list can include suitable side AMCs and/or a temporal AMC. A number of the side AMCs on a side of the current block 610 can be determined by a shape and/or a size of the current block 610. Locations of the side AMCs can also be determined by the shape and/or the size of the current block 610.

After the candidate list is constructed, at an encoder, such as the encoder 100, an evaluation process can be performed to select an optimal merge candidate from the merge candidate list for the current block 610. For example, rate-distortion performance corresponding to each merge candidate can be calculated, and the merge candidate with the optimal rate-distorting performance can be selected. Accordingly, a merge index for the selected merge candidate can be determined for the current block 610 and signaled in a bitstream.

At a decoder, such as the decoder 200, after receiving the merge index of the current block 610, a similar candidate list construction process as described above can be performed. After a candidate list is constructed, a merge candidate can be selected from the candidate list based on the received merge index. Motion data of the selected merge candidate can be used for subsequent motion prediction of the current block 610.

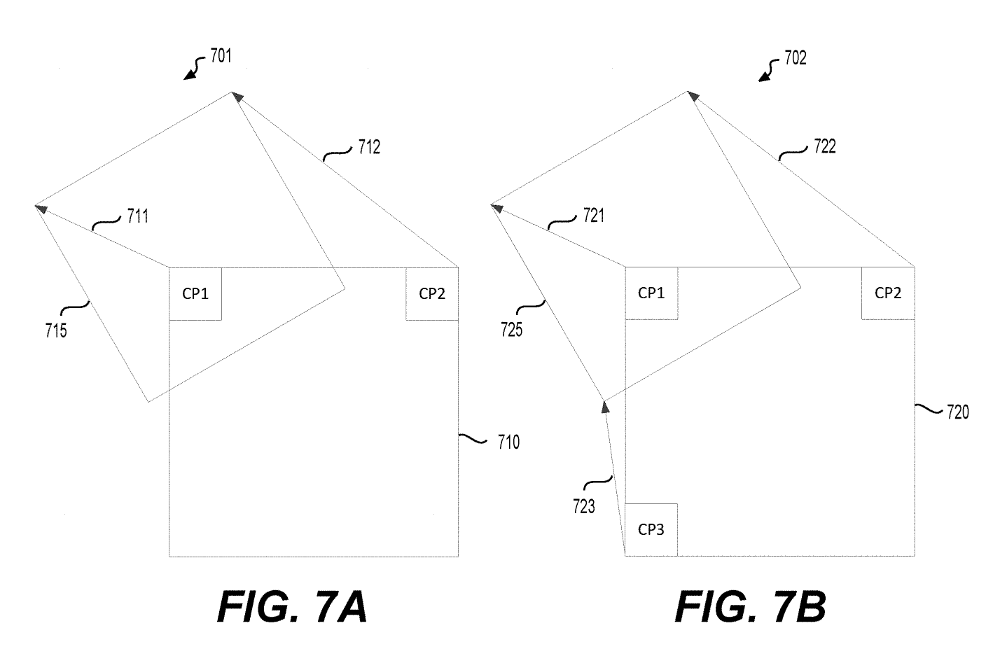

FIG. 7A-7B show examples of affine transformations 701 and 702, respectively based on affine motion models according to embodiments of the disclosure. In FIG. 7A, a block 710 is predicted using a four-parameter affine motion model where MVs of samples in the block 710 can be predicted based on two MVs 711 and 712 of two respective control points CP1 and CP2 within the block 710. A shape of a transformed block 715 can be identical to a shape of the block 710 after the affine transformation 701 based on the four-parameter affine motion model.

In an example, the MVs of the samples (or a MV field) in the block 710 can be described by the 4-parameter affine motion model using Eqs. (1) and (2):

x′=ax+by+e (1)

y′=−bx+ay+f (2)

where vx=x−x′, vy=y−y′, and a vector (vₓ, v_{y}) is a MV of a sample at a sample position (x, y) in the block 710. The equations (1) and (2) can be rewritten as Eq. (3):

vx=(1−a)x−by−e

vy=(1−a)y+bx−f (3)

As seen from the above Eqs. (1)-(3), the MVs of the samples in the block 710 can be described by the four-parameter affine motion model specified by the four parameters are a, b, e, and f In an example, the four parameters can be determined based on two known MVs of the block 710, such as the two MVs 711 and 712 of the two control points CP1 and CP2 within the block 710. Alternatively, the MVs of the samples in the block 710 can be described by the two MVs 711 and 712 as follows:

$$\{ \begin{matrix}{v}_{x} = \frac{( {v}_{1 x} - {v}_{0 x} )}{w} x - \frac{( {v}_{1 y} - {v}_{0 y} )}{w} y + {v}_{0 x} \\ {v}_{y} = \frac{( {v}_{1 y} - {v}_{0 y} )}{w} x + \frac{( {v}_{1 x} - {v}_{0 x} )}{w} y + {v}_{0 y}\end{matrix} \qquad ( 4 )$$

where (v₀ₓ, v_{0y}) is the MV 711 of the control point CP1 at a top-left corner of the block 710, (v₁ₓ, v_{1y}) is the MV 712 of the control point CP2 at a top-right corner of the block 710, and a parameter w is a width of the block 710.

In FIG. 7B, a block 720 is predicted using a six-parameter affine motion model where MVs of samples in the block 720 can be predicted based on three MVs 721, 722, and 723 of three respective control points CP1, CP2, and CP3 within the block 720. A shape a transformed block 725 can be different from a shape of the block 720 after the affine transformation 702 based on the six-parameter affine motion model.

Similar equations can be derived for the 6-parameter affine motion model to describe the MVs of the samples (or a MV field) in the block 720. Similarly, the 6 parameters in the 6-paramter affine motion model can be determined based on three known MVs of the block 720, such as the three MVs 721-723 of the three control points CP1-CP3 within the block 720. Alternatively, the MVs of the samples in the block 720 can be described by the three MVs 721-723.

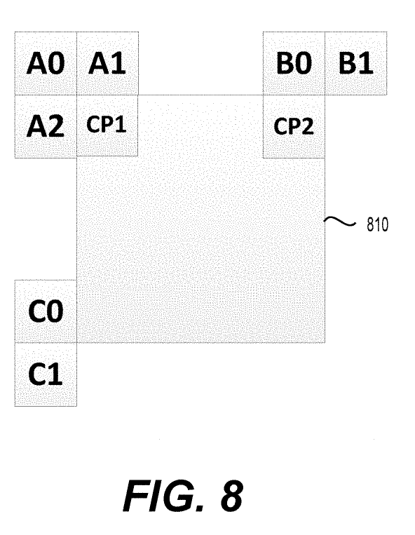

An affine motion model and an inter mode can be applied to a block, and thus resulting in an affine inter mode for the block. As described above, an affine motion model and a merge mode can be applied to a block, and thus resulting in an affine merge mode for the block. FIG. 8 shows an example of a current block 810 and spatial neighboring blocks A0, A1, A2, B0, B1, C0, and C1. In the FIG. 8 example, an affine motion model is specified using two MVs, i.e., a first MV and a second MV, of two respective control points, i.e., a first control point CP1 and a second control point CP2, in the current block 810.

In an embodiment of the affine inter mode, the affine inter mode is used to determine MVs of samples in the block 810. The first MV can be determined based on a first MV predictor (MVP) and a first MV difference of the first control point CP1, and the second MV can be determined based on a second MVP and a second MV difference of the second control point CP2. The first MVP can be determined from first MVP candidates that can be MVs of the spatially neighboring blocks A0, A1, and A2. Similarly, the second MVP can be determined from a set of second MVP candidates that can be MVs of the spatially neighboring blocks B0 and B1. The first MVP and the second MVP can be referred to as a MVP pair, and the MVP pair can be determined from a candidate list including, for example, candidate MVP pairs formed from the first MVP candidates and the second MVP candidates, respectively. An index of the selected candidate MVP pair can be signaled in a video bitstream. Further, the first MV difference and the second MV difference of the two respective control points CP1 and CP2 can be coded in the bitstream. In an example, when a size of the block 810 is equal to or larger than 16×16, a flag, e.g., an affine flag, can be signaled to indicate whether the affine inter mode is applied.

In an embodiment of the affine merge mode, the affine merge mode is used to determine MVs of samples in the block 810. Five spatially neighboring blocks C0, B0, B1, C1, and A0 of the block 810 are checked to determine whether one of the five spatially neighboring blocks C0, B0, B1, C1, and A0 is affine coded using either an affine inter mode or an affine merge mode. When one of the five neighboring blocks C0, B0, B1, C1, and A0 is determined to be affine coded, a flag, such as the affine flag, can be signaled to indicate that the block 810 is coded in an affine merge mode. In an example, an available affine coded neighbor is determined based on certain conditions and by sequentially checking the five neighboring blocks in the following order: C0, B0, B1, C1, and A0 where the neighbor C0 is checked first and the neighbor A0, if checked, is checked last. Affine parameters of the available affine coded neighbor can be used to derive the first MV and the second MV of the block 810. In the FIG. 8 example, a four-parameter affine motion model is used, the above descriptions can be suitably adapted to a six-parameter affine motion model.

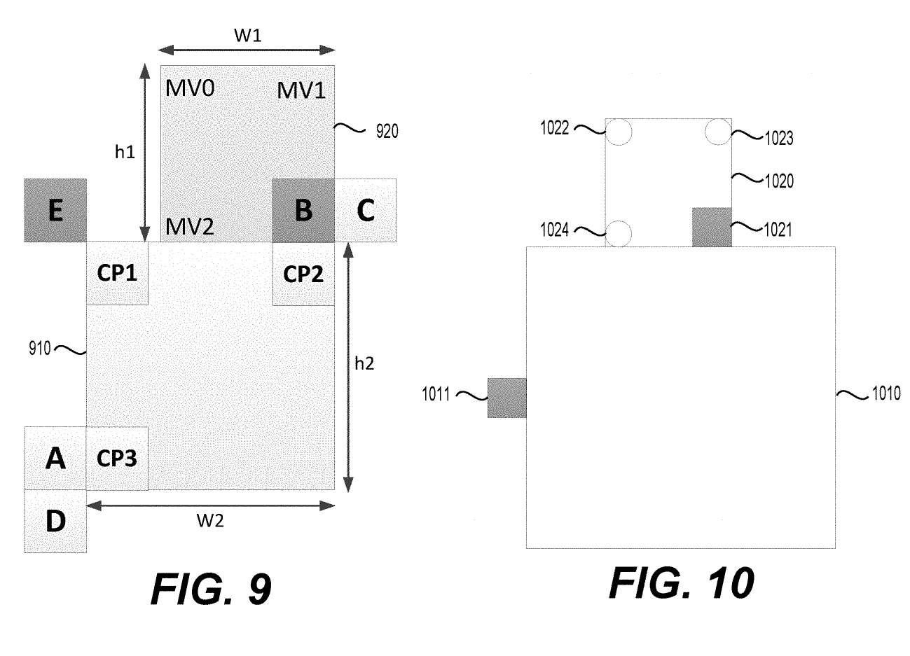

FIG. 9 shows an example of determining MVs for a block coded in an affine merge mode. In the FIG. 9 example, for a block 910, spatially neighboring blocks B and E are affine-coded neighbors, and spatially neighboring blocks A, C, and D are not affine-coded. In an affine merge mode, an affine-coded neighbor, such as the neighbor B can be used to derive an affine motion model for the block 910 as described below in an example.

The affine motion model is a six-parameter affine motion model where three MVs, i.e., a first MV, a second MV, and a third MV, for three respective control points CP1-CP3 can be used to determine MVs for samples in the block 910. Three MVs, i.e., MV0-MV2 shown in FIG. 9, of the affine-coded neighbor B can be used to derive an affine merge candidate for the current block 910 as described below.

The affine merge candidate including, for example, three MV predictors for the three control points CP1-CP3 can be derived as below.

V₀ₓ=V_{B0x}+(V_{B2x}−V_{B0x})*(posCurPU_Y−posRefPU_Y)/RefPU_height+(V_{B1x}−V_{B0x})*(posCurPU_X−posRefPU_X)/W₁ (5)

V_{0y}=V_{B0y}+(V_{B2y}−V_{B0y})*(posCurPU_Y−posRefPU_Y)/RefPU_height+(V_{B1y}−V_{B0y})*(posCurPU_X−posRefPU_{—X})/W₁ (6)

V₁ₓ=V_{B0x}+(V_{B1x}−V_{B0x})*W₂/W₁ (7)

V_{1y}=V_{B0y}+(V_{B1y}−V_{B0y})*W₂/W₁ (8)

V₂ₓ=V_{B0x}+(V_{B2x}−V_{B0x})*W₂/W₁ (9)

V_{2y}=V_{B0y}+(V_{B2y}−V_{B0y})*W₂/W₁ (10)

where (V₀ₓ, V_{0y}) is a first MVP, (V₁ₓ, V_{1y}) is a second MVP, (V₂ₓ, V_{2y}) is a third MVP of the affine merge candidate for the current block 910, (V_{B0x}, V_{B0y}) is MV0, (V_{B1x}, V_{B1y}) is MV1, and (V_{B2x}, V_{B2y}) is MV2, (posCurPU_X, posCurPU_Y) represents a position of a top-left sample of the block 910 relative to a top-left sample of the picture, (posRefPU_X, posRefPU_Y) represents a position of a top-left sample of the neighbor B relative to the top-left sample of the picture, W₂ is a width of the block 910, W₁ is a width of the neighbor B, and RefPU_height is a height of the neighbor B.

In an embodiment, an affine merge candidate has multiple MVs while a non-affine merge candidate (referred to as a normal merge candidate) has one translational MV. When a candidate block is affine-coded, a normal merge candidate with one translational MV and an affine merge candidate with multiple MVs can be derived. When a candidate block is not affine-coded, only a normal merge candidate with one translational MV can be derived. An affine merge candidate can include 2 MVs, 3 MVs, or the like.

In some examples, such as in the HEVC standard, all the merge candidates are normal merge candidates, and thus a merge candidate list can be constructed using normal merge candidates. Referring to FIG. 9, when the MVs of the five neighboring blocks A to E are used and an order of priority is A, B, C, D, and E, with the neighbor A having the highest priority and the neighbor E has the lowest priority, the merge candidate list including the normal merge candidates can be derived as {C_{A}, C_{B}, C_{C}, C_{D}, C_{E}} where C_{A}, C_{B}, C_{C}, C_{D}, C_{E} represent the normal merge candidates of the neighbors A, B, C, D, and E, respectively. According to aspects of the disclosure, a merge candidate list can include affine merge candidates and can be constructed as described below.

In a first construction method, one or more normal merge candidates can be replaced by one or more corresponding affine merge candidates. When a candidate block is affine-coded, an affine merge candidate replaces a corresponding normal MV, a translational MV of the same candidate block. For example, the updated merge candidate list can be: {C_{A}, C_{B-affine}, C_{C}, C_{D}, C_{E-affine}}, where C_{B-affine} and C_{E-affine} are the affine merge candidates of the affine-coded candidate blocks B and E, respectively.

In a second construction method, an affine merge candidate can be inserted after a respective normal merge candidate. For example, the updated merge candidate list for the FIG. 9 example can be: {C_{A}, C_{B}, C_{B-affine}, C_{C}, C_{D}, C_{E}, C_{E-affine}}.

In a third construction method, only one affine merge candidate, such as a first available affine merge candidate, is inserted at the beginning of the merge candidate list. For example, the merge candidate list can be: {C_{B-affine}, C_{A}, C_{B}, C_{C}, C_{D}, C_{E}}.

In a fourth construction method, all available affine merge candidates are inserted in front of the merge candidate list. For example, the updated merge candidate list can be: {C_{B-affine}, C_{E-affine}, C_{A}, C_{B}, C_{C}, C_{D}, C_{E}}.

In a fifth construction method, one affine merge candidate, such as a first available affine merge candidate, is inserted in front of the merge candidate list. In addition, when a candidate block is affine-coded and a respective affine merge candidate is not inserted in the beginning of the merge candidate list, the translational MV of the candidate block is replaced with the affine merge candidate. For example, the updated merge candidate list can be: {C_{B-affine}, C_{A}, C_{B}, C_{C}, C_{D}, C_{E-affine}}.

In a sixth construction method, one affine merge candidate, such as a first available affine merge candidate, is inserted in front of the merge candidate list. In addition, when a candidate block is affine-coded and a respective affine merge candidate is not inserted in front of the merge candidate list, then the affine merge candidate of the candidate block is inserted after the normal merge candidates. For example, the updated merge candidate list can be: {C_{B-affine}, C_{A}, C_{B}, C_{C}, C_{D}, C_{E}, C_{E-affine}}.

In a seventh construction method, when a candidate block is affine-coded and a respective affine merge candidate is not included in the merge candidate list, instead of using a respective translational MV of the candidate block, the affine merge candidate is used. On the other hand, when the affine merge candidate is redundant, the normal merge candidate is used.

In an eighth construction method, when all the candidate blocks are not affine-coded, one pseudo affine merge candidate can be inserted into the merge candidate list. The pseudo affine candidate can be generated by combining two or three MVs of the candidate blocks. For example, a first MV of the pseudo affine merge candidate can be the translation MV of the neighbor D, a second MV of the pseudo affine merge candidate can be the translation MV of the neighbor A, and a third MV of the pseudo affine merge candidate can be the translation MV of the neighbor C.

In the third, fifth, and sixth methods described above, the first affine merge candidate is inserted at a certain pre-defined position in the merge candidate list. For example, the pre-defined position can be the first position. Alternatively, the first affine merge candidate can be inserted at a fourth position in the merge candidate list. Accordingly, the updated merge candidate list can be {C_{A}, C_{B}, C_{C}, C_{B-affine}, C_{D}, C_{E}} in the third construction method, {C_{A}, C_{B}, C_{C}, C_{B-affine}, C_{D}, C_{E-affine}} in the fifth construction method, and {C_{A}, C_{B}, C_{C}, C_{B-affine}, C_{D}, C_{E-affine}} in the sixth construction method. The pre-defined position can be signaled at a sequence level, a picture level, a slice level, or the like.

After the merge candidate construction described above, a pruning process can be performed. For example, for an affine merge candidate having three MVs at three control points, respectively, when the three MVs are identical to three other MVs at three other control points of another affine merge candidate in the merge candidate list, the affine merge candidate can be removed from the merge candidate list. A merge candidate list can include affine merge candidates and/or normal merge candidates that are not affine merge candidate. In an example, a merge candidate list includes only normal merge candidates and is used in a normal merge mode. In an example, a merge candidate list includes only affine merge candidates and is used in an affine merge mode. In an example, a merge candidate list includes both normal merge candidates and affine merge candidates and is used in a unified merge mode.

As described above, an affine merge candidate can be used in an affine merge mode. In addition, an affine merge candidate can also be used in a unified merge mode where a merge candidate list includes the affine merge candidate and at least one normal merge candidate. In examples described above, an affine merge candidate can be selected from affine-coded spatial neighbors located at respective corners of a block, such as the neighbors E and B of the current block 910. In some examples, an affine merge candidate can be selected from affine-coded spatial neighbors located near corners of a block.

As can be seen from the examples of tree structure based partitioning schemes described with reference to FIGS. 3A-3C, 4A-4C, 5A-5B, blocks can have variable sizes and shapes, and thus when an affine motion model is used for a current block, the variable AMC approach where a number and/or locations of side AMC can be varied according to a shape and/or a size of the current block can be advantageous and improve coding efficiency.

FIG. 10 shows an example of an AMC side position according to an embodiment of the disclosure. Two affine-coded side neighbors 1011 and 1021 of a block 1010 are shown. The top affine-coded side neighbor (or top neighbor) 1021 is located near a middle position of a top side of the block 1010, and the left affine-coded side neighbor 1011 is located at a middle position of a left side of the block 1010. When a side AMC corresponding to the top neighbor 1021 is selected, an affine-coded CB 1020 including the top neighbor 1021 is identified, and MVs of respective control points such as the control points 1022-1024 for a six-parameter affine motion model are obtained from an affine motion model for the affine-coded CB 1020. Subsequently, MVs at respective control points of the block 1010 can be determined based on the MVs of the respective control points of the CB 1020. In an example, a four-parameter affine motion model can be used for the current block 1010, and thus, the two MVs at the two control points of the block 1010 can be determined based on the two MVs of the control points such as the control points 1022-1023 of the affine-coded CB 1020, such as shown in Eqs. (1)-(4).

As described above, in order to improve coding efficiency, the variable AMC approach can be used, and thus, a number of AMC side blocks or a number of side AMCs or a number of AMC side positions on a side of the current block can be determined based on a shape and/or a size of the current block. Further, a number of side AMCs on one side of the current block can be different from a number of side AMCs on another side of the current block. The number of side AMCs on each side can vary according to a size or a shape of the current block, and can be an integer that is equal to or larger than zero. In some examples, the number of side AMCs on a side of the current block can increase with a side length. In some examples, a number of side AMCs for the current block can increase with the size of the current block. According to aspects of the disclosure, positions of side AMCs or AMC side positions can be determined based on the shape and/or the size of the current block.

In an embodiment, the size of the current block can be indicated by a side length of the current block, such as a width, a height, or the like. The size of the current block can also be indicated by an area of the current block. The shape of the current block can be indicated by an aspect ratio, such as a width-over-height ratio that is the ratio of the width over the height, a height-over-width ratio that is the ratio of the height over the width, or the like.

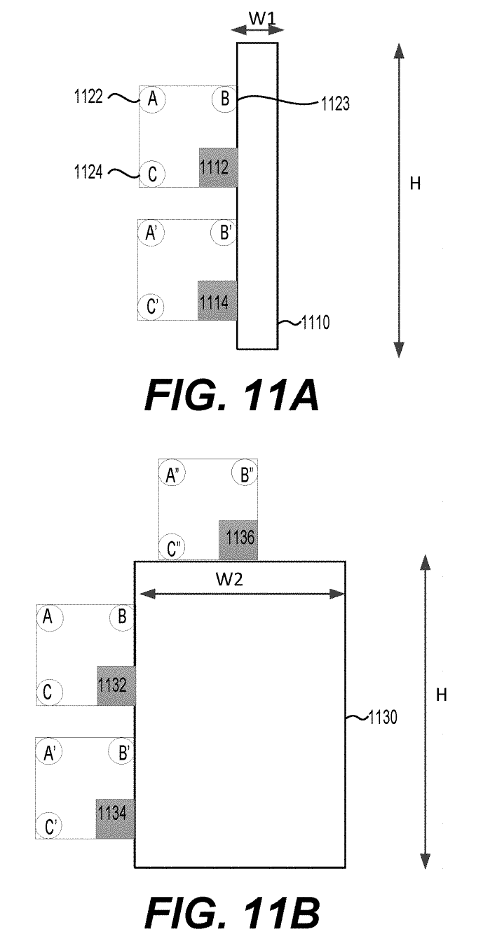

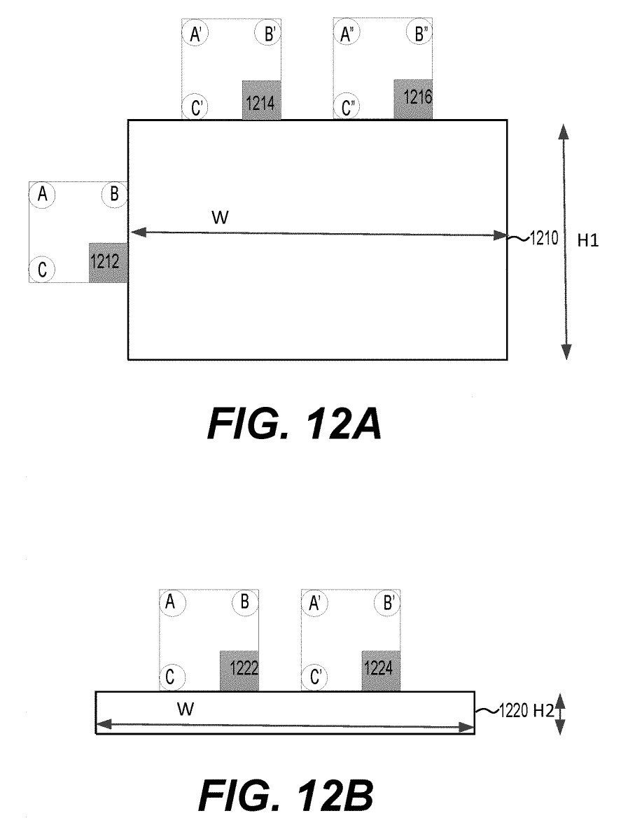

FIGS. 11A-11B and 12A-12B show examples of the variable AMC approach. In the examples, a number of side AMCs of a current block can be determined based on a size of the current block. For example, the number of side AMCs can increase when the size of the current block increases.

Specifically, a number of side AMCs on a side of the current block can be determined based on a side length. For example, the number of side AMCs on the side of the current block increases with the side length. A certain number of side AMCs can be used for a certain side length. For example, the number of side AMCs is: 0 for the side length less than or equal to 4 pixels, 1 for the side length between 8 pixels and 16 pixels, 2 for the side length between 17 pixels and 32 pixels, and/or the like. Based on the number of side AMCs, locations of the side AMCs or corresponding AMC side blocks can be determined accordingly for the current block.

Based on the above description, during an encoding or decoding process, when a current block predicted using an affine motion model is processed with a merge mode, an encoder or decoder can determine a number and locations of side AMCs according to a size of the current block.

FIG. 11A shows a current block 1110 having two AMC side blocks 1112 and 1114 at a left side located at two AMC side positions, thus two side AMCs can be derived from the two AMC side blocks. There are no side AMCs for a top side of the current block 1110 because a width W₁ of, for example, 4 pixels is small, and thus there is no side AMCs for the top side. In contrast, FIG. 11B shows a current block 1130 that has a same height H as the current block 1110, and thus a similar number (2) of AMC side blocks 1132 and 1134 on a left side of the current block 1130 as that of the current block 1110. However, a top side of the current block 1130 having a width W₂ is wider than the current block 1110. For example, the top side has a length of 16 pixels. Accordingly, a side AMC 1136 is determined to be located on the top side. As seen above, the current blocks 1110 and 1130 have the same height H, and thus have the same number (2) of side AMCs on the left side that are located at two different AMC side positions. The current block 1110 is narrow, and thus has no side AMCs for the top side while the current block 1130 is wider and thus has 1 side AMC for the top side.

FIG. 12A-12B show two current blocks 1210 and 1220 that have a same width W but different heights H₁ and H₂. For example, the height H₁ of the current block 1210 is 24 pixels, and the height H₂ of the current block 1220 is 4 pixels. Accordingly, a same number (2) of AMC side blocks are determined for the two current blocks 1210 and 1220 on a respective top side, while different numbers of AMC side blocks are determined for the two current blocks 1210 and 1220 on a respective left side. Specifically, the left side of the current block 1220 has no AMC side blocks, while the left side of the current block 1210 has 1 AMC side block 1212. Therefore, the current blocks 1210 and 1220 have the same width W, and thus have the same number (2) of side AMCs on the top side that are located at two different AMC side positions. The current block 1220 is shorter, and thus has no side AMCs for the left side while the current block 1210 is taller and thus has 1 side AMC for the left side.

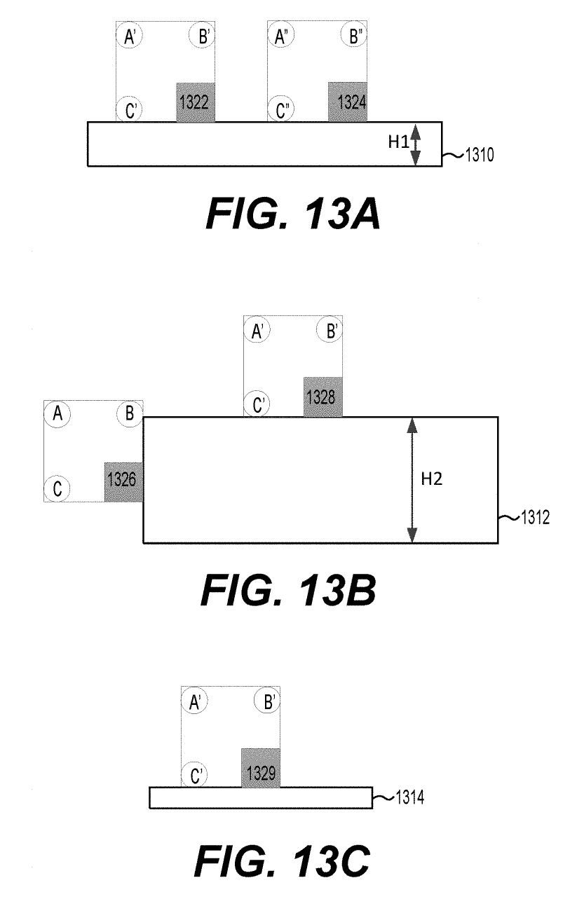

FIGS. 13A-13C show examples of the variable AMC approach. In the examples, a number of side AMCs or AMC side blocks or AMC side positions of a current block can be determined based on a shape of the current block, such as a width-over-height ratio of the current block. Further, the number of side AMCs or AMC side blocks or AMC side positions of the current block can be determined based on the shape and/or a size of the current block. For example, a number of side AMCs along a top side can be determined based on the width and the width-over-height ratio.

In an example, when the width-over-height ratio is above a threshold, a number of side AMCs on a side can be different from a number of side AMCs on the side when the width-over-height ratio is below the threshold. In FIG. 13A, a current block 1310 has two AMC side blocks 1322 and 1324 on the top side, and no AMC side blocks along the left side. In FIG. 13B, a current block 1312 has a same width as the current block 1310 but a larger height H₂ than a height H₁ of the current block 1310. The width-over-height ratio of the current block 1312 is smaller than that of the current block 1310. Accordingly, one AMC side block 1328 is determined for the top side of the current block 1312 that is fewer than the two AMC side blocks for the top side of the current block 1310. In addition, one AMC side block 1326 is determined on a left side of the current block 1312.

FIG. 13C shows a current block 1314 that has the same width-over-height ratio as that of the current block 1310. However, due to a smaller area of the current block 1314, the current block 1314 has a different number of AMC side blocks or side AMCs. Specifically, the current block 1314 has one AMC side block 1329 for a top side that is less than two AMC side blocks 1322 and 1324 for the top side of the current block 1310.

According to aspects of the disclosure, AMC side positions of AMC side blocks for a current block can be at any suitable positions, such as a suitable position on a top or left side of the current block. In an example, the AMC side positions are at or near a middle position of the respective side of the current block. In various embodiments, the AMC side positions are not at or near corners of the current block.

Based on the above description, during an encoding or decoding process, an encoder or a decoder can determine a number and locations of side AMCs or AMC side positions according to a shape, such as an aspect ratio of the current block, as well as a size such as a width, a height, and an area of the current block.

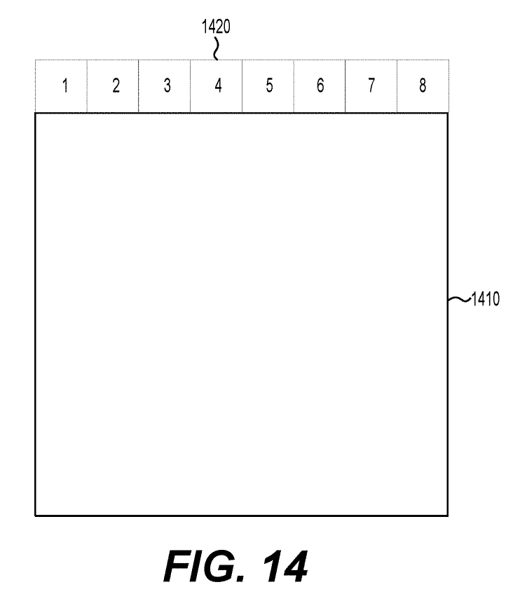

FIG. 14 shows examples of the variable AMC approach. In the examples, one side AMC is derived from an AMC side block that is on a side, such as a top side, a left side, or the like of a current block, and the AMC side block is located at or near a middle location of the side. Various methods can be applied to determine an AMC side position for the AMC side block.

In an embodiment, the AMC side position is determined as follows. A spatial neighbor at a middle position of the side is determined where the middle position meets a first condition, such as a pre-defined condition. Then the spatial neighbor is checked to determine whether the spatial neighbor is within an affine-coded CB. When the spatial neighbor is not within an affine-coded CB, there is no AMC side block available, thus no side AMC, for the current block on the side. Otherwise, MVs of control points of the affine-coded CB are determined. Subsequently, a side AMC for the current block is determined based on the MVs of the control points of the affine-coded CB. Accordingly, the middle position is the AMC side position.

The middle position can be calculated as follows using a top side of a current block 1410 as an example. Referring to FIG. 14, a block width L₂ of spatially neighboring blocks 1-8 is 4. The middle position of the top side of the current block 1410 can be calculated as: L₁/(2L₂), where L₁ is a length of the top side of the current block 1410, and thus in the example in FIG. 14, the middle position is at the neighbor 4. Alternatively, the middle position can be equal to: L₁/(2L₂)+k, where k is a small positive or negative integer, such as ±1, ±2, ±3, or the like. When k is equal to 1, the middle position is at the neighbor 5 as shown in FIG. 14. The above process can be suitably adapted and applied to another side, such as a left side of the current block 1410.

In an embodiment, when an AMC side block is available for the top side and another AMC side block is available for the left side, more than one side AMCs including a side AMC on the top side and a side AMC on a left side, can be inserted into a merge candidate list.

Alternatively, the AMC side position can be searched around an initial position. In an example, the initial position can be the exact middle position or a positon that is close to the exact middle position. Further, positions around the initial position can be searched according to a search order, such as: the initial position, the initial position −1, the initial position +1, the initial position −2, the initial position +2, and so on. Another example of the search order can be: the initial position, the initial position +1, the initial position −1, the initial position +2, the initial position −2, and so on. In an example, 1, 2, or the like described above represents a block width or a block height of the spatially neighboring blocks of the current block 1410. Any suitable search order can be used and thus the search order is not limited to the above examples.

There can be a size constraint to the variable AMC approach. For example, when an area of a current block is larger than a threshold, then a side AMC can be inserted into a merge candidate list. Otherwise, the side AMC is not inserted into the merge candidate list. In another example, when an area of a current block is smaller than a threshold, a side AMC is inserted into a merge candidate list. Otherwise, the side AMC is not inserted into the merge candidate list.

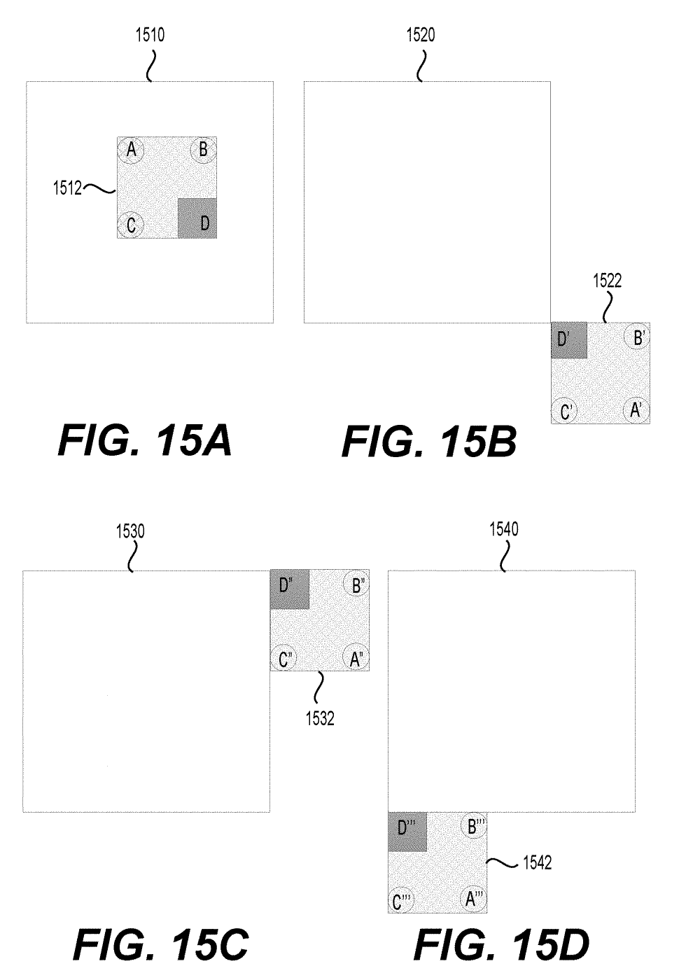

According to aspects of the disclosure, an affine merge candidate of a current block can be from an AMC temporal block of the current block. FIG. 15A-15D show examples of an AMC temporal block of a current block. In the FIG. 15A example, an AMC temporal block D of a current block 1510 in a picture is within a CB 1512 in a reference picture of the current block 1510. Further, the AMC temporal block D is collocated at or near a center position of the current block 1510. A temporal AMC for the current block can be derived based on an affine motion model of the CB 1512, as described above. In an example, the affine motion model of the CB 1512 can be described by MVs at control points A, B, and C.

In the FIG. 15B example, an AMC temporal block D′ of a current block 1520 in a picture is within a CB 1522 in a reference picture of the current block 1520. Further, the AMC temporal block D′ is at a bottom-right corner of a collocated block of the current block 1520. A temporal AMC for the current block 1520 can be derived based on an affine motion model of the CB 1522. In an example, the affine motion model of the CB 1522 can be described by MVs at control points A′, B′, and C′.

In the FIG. 15C example, an AMC temporal block D″ of a current block 1530 in a picture is within a CB 1532 in a reference picture of the current block 1530. Further, the AMC temporal block D″ is at a top-right corner of a collocated block of the current block 1530. Similarly, in the FIG. 15D example, an AMC temporal block D′″ of a current block 1540 in a picture is within a CB 1542 in a reference picture of the current block 1540. Further, the AMC temporal block D′″ is at a bottom-left corner of a collocated block of the current block 1540.

The above methods can be implemented in encoders and/or decoders, such as an inter prediction module of an encoder, and/or an inter prediction module of a decoder.

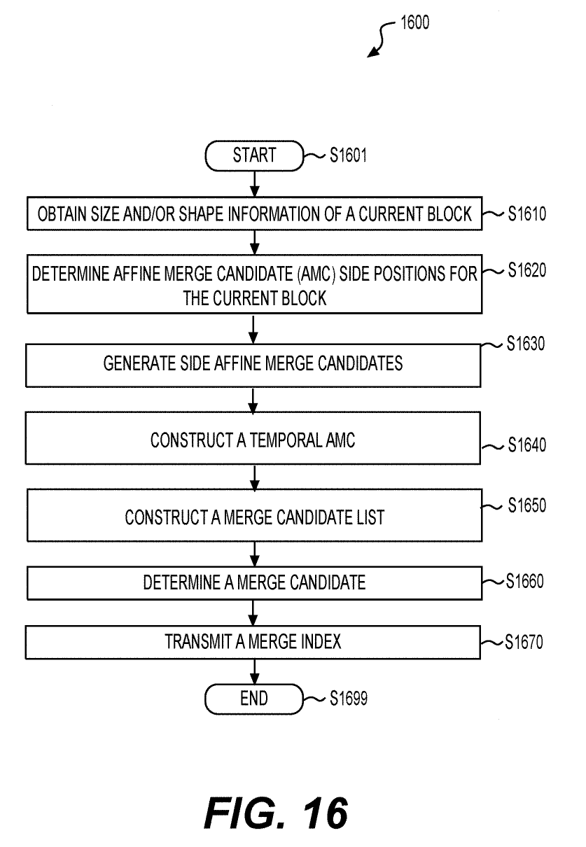

FIG. 16 shows a merge mode encoding process 1600 according to an embodiment of the disclosure. The merge mode encoding process 1600 uses the variable AMC approach for merge mode processing. The merge mode encoding process 1600 can be performed at the variable AMC module 126 in the encoder 100 in FIG. 1 example. The encoder 100 is used for description of the merge mode encoding process 1600. The process 1600 starts from S1601 and proceed to S1610.

At S1610, size and/or shape information of a current block is received. For example, a picture can be partitioned with a tree structure based partitioning method, and size and/or shape information of blocks can be stored in a tree structure based data structure. The size and/or shape information can be sent to the variable AMC module 126. The size information can include a width, a height, an area, and/or the like of the current block. The shape information can include an aspect ratio, optionally a height or a width of the current block, or the like. The current block can correspond to a luma component or a chroma component in one example.

At S1620, AMC side positions for the current block can be determined. For example, when the current block is determined to be predicated using an affine motion model in the merge mode, the variable AMC approach can be used for the merge mode processing. Accordingly, a number and locations of the AMC side positions of AMC side blocks can be determined according to a size and/or a shape of the current block, as described above, for example, with reference to FIGS. 11A-11B, 12A-12B, 13A-13C, and FIG. 14.

When the number of AMC side positions on each side of the current block is determined, locations of the corresponding AMC side positions can be determined using any suitable method. For example, an equal division placement method can be used where a substantially equal distance is between adjacent AMC side positions or AMC side blocks. More specifically, locations of AMC side positions on a side of the current block can be determined based on a side length of the current block, an aspect ratio of the current block, and/or a number of the AMC side positions on the side. Optionally, a refinement search process can be performed to search for an additional AMC side position when an original AMC side position is unavailable.

At S1630, side AMCs are generated at the corresponding AMC side positions of the AMC side blocks. For example, for an AMC side block located at one of the AMC side positions, an affine-coded CB that includes the AMC side blocks is identified. An affine motion model of the affine-coded CB, such as MVs of control points of the affine-coded CB, can be used to derive a side AMC corresponding to the AMC side block.

At S1640, a temporal AMC is generated. In an example, an AMC temporal block is determined and the temporal AMC corresponding to the AMC temporal block can be generated similarly as described in S1630. As described above, the AMC temporal block can be selected from the multiple temporal blocks located at a reference picture that includes a collocated block of the current block where the multiple temporal blocks can surround, overlap with, or be within the collocated block.

At S1650, a merge candidate list including merge candidates can be constructed based on the side AMCs determined at S1630 and the temporal AMC determined at S1640. The merge candidates can include one or more of the side AMCs determined at S1630 and/or the temporal AMC determined at S1640. The selection may consider whether a merge candidate is available or redundant, as described above. If a number of the merge candidate list is less than a preconfigured length of the merge candidate list, additional motion data can be created. In various examples, processes for construction a merge candidate list can vary. As described above, the merge candidate can also include normal merge candidates.

At S1660, a merge candidate can be determined. For example, merge candidates in the merge candidate list can be evaluated, for example, using a rate-distortion optimization based method. An optimal merge candidate can be determined, or motion data with a performance above a threshold can be identified. Accordingly, a merge index indicating position of the determined merge candidate in the merge candidate list can be determined. In an example, the selected merge candidate can be a side AMC or a temporal AMC determined in S1630 or S1640.

At S1670, the merge index can be transmitted from the encoder 100 in a bitstream, for example, to a decoder. The process 1600 proceeds to S1699 and terminates.

The process 1600 can be suitably adapted, for example, by omitting certain steps such as the step S1640, by adjusting orders of certain steps, by combining certain steps, or the like. Each step in the process 1600 can also be adapted.

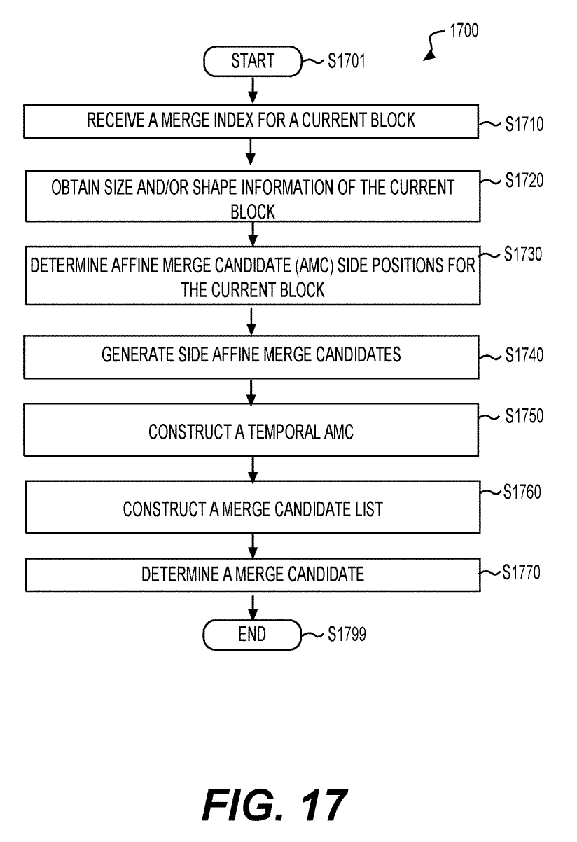

FIG. 17 shows a merge mode decoding process 1700 according to an embodiment of the disclosure. The merge mode decoding process 1700 uses the variable AMC approach for merge mode processing. The merge mode decoding process 1700 can be performed at the variable AMC module 226 in the decoder 200 in FIG. 2 example. The decoder 200 is used for explanation of the merge mode decoding process 1700. The process 1700 can start from S1701 and proceed to S1710.

At S1710, a merge index of current block can be received. The current block can be encoded using the variable AMC approach at a video encoder. For example, the current block is associated with a merge flag indicating the current block is encoded with an affine merge mode having side AMCs. The merge flag and the merge index can be associated with the current block and carried in the bitstream 201.

At S1720, size and/or shape information of the current block can be obtained, for example, explicitly from the bitstream 201.

At S1730, AMC side positions for the current block can be determined.

At S1740, side AMCs are generated at the corresponding AMC side positions of the AMC side blocks.

At S1750, a temporal AMC is generated.

At S1760, a merge candidate list including merge candidates can be constructed based on the side AMCs determined at S1740 and the temporal AMC determined at S1750. In an embodiment, the merge candidate list is identical to the merge candidate list generated at S1650.

Steps S1730, S1740, S1750, and S1760 can be similar or identical to the steps S1620, S1630, S1640, and S1650, and thus, detailed descriptions are omitted for purposes of clarity.

At S1770, a merge candidate of the current block can be determined based on the merge candidate list and the received merge index. The merge candidate includes motion data that can be used for generate a prediction of the current block at the motion compensation module 221. The process 1700 proceeds to S1799 and terminates.

Similarly, the process 1700 can be suitably adapted, for example, by omitting certain steps such as the step S1750, by adjusting orders of certain steps, by combining certain steps, or the like. Each step in the process 1700 can also be adapted.

The processes and functions described herein can be implemented as a computer program which, when executed by one or more processors, can cause the one or more processors to perform the respective processes and functions. The computer program may be stored or distributed on a suitable medium, such as an optical storage medium or a solid-state medium supplied together with, or as part of, other hardware. The computer program may also be distributed in other forms, such as via the Internet or other wired or wireless telecommunication systems. For example, the computer program can be obtained and loaded into an apparatus, including obtaining the computer program through physical medium or distributed system, including, for example, from a server connected to the Internet.

The computer program may be accessible from a computer-readable medium providing program instructions for use by or in connection with a computer or any instruction execution system. A computer readable medium may include any apparatus that stores, communicates, propagates, or transports the computer program for use by or in connection with an instruction execution system, apparatus, or device. The computer-readable medium can be magnetic, optical, electronic, electromagnetic, infrared, or semiconductor system (or apparatus or device) or a propagation medium. The computer-readable medium may include a computer-readable non-transitory storage medium such as a semiconductor or solid state memory, magnetic tape, a removable computer diskette, a random access memory (RAM), a read-only memory (ROM), a magnetic disk and an optical disk, and the like. The computer-readable non-transitory storage medium can include all types of computer readable medium, including magnetic storage medium, optical storage medium, flash medium, and solid state storage medium.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A method for video coding, comprising:
determining a set of affine merge candidate (AMC) positions of a set of AMC blocks coded using affine motion models for a current block in a current picture, the set of AMC blocks including at least one of: a set of AMC side blocks that are spatially neighboring blocks located on one or more sides of the current block in the current picture and an AMC temporal block in a reference picture of the current block, the current block being predicted from the reference picture using a merge mode;
generating a set of affine merge candidates for the current block corresponding to the set of AMC blocks; and
constructing a merge candidate list for the current block including the set of affine merge candidates.

2. The method of claim 1, wherein the set of AMC side blocks is determined based on one of: size information and shape information of the current block.

3. The method of claim 2, further comprising:
determining a number of the set of AMC side blocks based on one of: the size information and the shape information of the current block, the size information including at least one of: a height of the current block, a width of the current block, and an area of the current block, and the shape information including an aspect ratio of the current block.

4. The method of claim 3, wherein the set of AMC side blocks includes a set of AMC top blocks located on a top side of the current block and determining the number of the set of AMC side blocks includes:
determining a number of the set of AMC top blocks based on the width of the current block and/or the aspect ratio of the current block.

5. The method of claim 3, wherein the set of AMC side blocks includes a set of AMC left blocks located on a left side of the current block and determining the number of the set of AMC side blocks includes:
determining a number of the set of AMC left blocks based on the height of the current block and/or the aspect ratio of the current block.

6. The method of claim 2, wherein one of the set of AMC positions is of one of the set of AMC side blocks and determining the set of AMC positions comprises:
determining the one of the set of AMC positions based on one of: the size information and the shape information of the current block.

7. The method of claim 6, wherein the set of AMC side blocks includes a set of AMC top blocks located on a top side of the current block and one of the set of AMC top blocks is located at the one of the set of AMC positions and determining the one of the set of AMC positions includes:
determining the one of the set of AMC positions based on at least one of: the width of the current block, the aspect ratio of the current block, and a number of the set of AMC top blocks.

8. The method of claim 6, wherein the set of AMC side blocks includes a set of AMC left blocks located on a left side of the current block and one of the set of AMC left blocks is located at the one of the set of AMC positions and determining the one of the set of AMC positions includes:
determining the one of the set of AMC positions based on at least one of: the height of the current block, the aspect ratio of the current block, and a number of the set of AMC left blocks.

9. The method of claim 1, wherein the AMC temporal block is within a collocated block of the current block, the collocated block being in the reference picture of the current block.

10. The method of claim 1, wherein the AMC temporal block is located at one of: a bottom-right corner, a top-right corner, and a bottom-left corner of a collocated block of the current block, the collocated block being in the reference picture of the current block.

11. The method of claim 1, wherein generating the set of affine merge candidates for the current block corresponding to the set of AMC blocks further comprises:
for one of the set of AMC blocks,
identifying an affine-coded coding block for the one of the set of AMC blocks;
obtaining first control points of the affine-coded coding block; and
determining, based on first motion vectors of the first control points, second motion vector predictors of second control points for the current block, the second motion vector predictors being one of the set of affine merge candidates corresponding to the one of the set of AMC blocks.

12. An apparatus for video coding, comprising processing circuitry configured to:
determine a set of affine merge candidate (AMC) positions of a set of AMC blocks coded using affine motion models for a current block in a current picture, the set of AMC blocks including at least one of: a set of AMC side blocks that are spatially neighboring blocks located on one or more sides of the current block in the current picture and an AMC temporal block in a reference picture of the current block, the current block being predicted from the reference picture using a merge mode;
generate a set of affine merge candidates for the current block corresponding to the set of AMC blocks; and
construct a merge candidate list for the current block including the set of affine merge candidates.

13. The apparatus of claim 12, wherein the set of AMC side blocks is determined based on one of: size information and shape information of the current block.

14. The apparatus of claim 13, wherein the processing circuitry is configured to:
determine a number of the set of AMC side blocks based on one of: the size information and the shape information of the current block, the size information including at least one of: a height of the current block, a width of the current block, and an area of the current block, and the shape information including an aspect ratio of the current block.

15. The apparatus of claim 14, wherein the set of AMC side blocks includes a set of AMC top blocks located on a top side of the current block and the processing circuitry is configured to:
determine a number of the set of AMC top blocks based on the width of the current block and/or the aspect ratio of the current block.

16. The apparatus of claim 14, wherein the set of AMC side blocks includes a set of AMC left blocks located on a left side of the current block and the processing circuitry is configured to:
determine a number of the set of AMC left blocks based on the height of the current block and/or the aspect ratio of the current block.

17. The apparatus of claim 13, wherein one of the set of AMC positions is of one of the set of AMC side blocks and the processing circuitry is configured to:
determine the one of the set of AMC positions based on one of: the size information and the shape information of the current block.

18. The apparatus of claim 17, wherein the set of AMC side blocks includes a set of AMC top blocks located on a top side of the current block and one of the set of AMC top blocks is located at the one of the set of AMC positions and the processing circuitry is configured to:
determine the one of the set of AMC positions based on at least one of: the width of the current block, the aspect ratio of the current block, and a number of the set of AMC top blocks.

19. The apparatus of claim 17, wherein the set of AMC side blocks includes a set of AMC left blocks located on a left side of the current block and one of the set of AMC left blocks is located at the one of the set of AMC positions and the processing circuitry is configured to:
determine the one of the set of AMC positions based on at least one of: the height of the current block, the aspect ratio of the current block, and a number of the set of AMC left blocks.

20. A non-transitory computer-readable medium storing instructions that, when executed by a processing circuit, cause the processing circuit to perform a method for video coding in merge mode or skip mode, the method comprising:
determining a set of affine merge candidate (AMC) positions of a set of AMC blocks coded using affine motion models for a current block in a current picture, the set of AMC blocks including at least one of: a set of AMC side blocks that are spatially neighboring blocks located on one or more sides of the current block in the current picture and an AMC temporal block in a reference picture of the current block, the current block being predicted from the reference picture using a merge mode;
generating a set of affine merge candidates for the current block corresponding to the set of AMC blocks; and
constructing a merge candidate list for the current block including the set of affine merge candidates.
